(19) United States
(12) Patent Application Publication
(10) Pub. No.: US 2017/0092431 A1
(43) Pub. Date: Mar. 30, 2017

(54) GRAPHENE CAPACITOR, PARTICULARLY FOR AUDIO SYSTEMS, AND ITS USE

(71) Applicant: Piotr NAWROCKI, Inowroclaw (PL)

(72) Inventor: Piotr NAWROCKI, Inowroclaw (PL)

(21) Appl. No.: 14/866,589

(22) Filed: Sep. 25, 2015

(51) Int. Cl. H01G 9/07; H01G 9/012; H01G 9/10

(52) U.S. Cl. CPC H01G 9/07; H01G 9/10; H01G 9/012; B82Y 99/00

(57) ABSTRACT

Embodiments of the present invention provide a capacitor that includes two electric cladding elements with at least one graphene layer. The two electric cladding elements are separated by a layer of electrically insulating polymer. The layer of electrically insulating polymer is in a form of a wound tape arranged in a housing, wherein each of the electric cladding elements is electrically connected to electrical connectors led through an external casing. The present invention also encompasses the use of such a capacitor as an important element of electronic circuitry in audio systems.

### TECHNICAL FIELD

The present invention generally relates to a capacitor—an electrical circuit components, capable of collecting an electrical charge using the elements made of graphene, the use of which significantly reduces the electrical resistances and has positive influence on other characteristics of the operation manifested during use in electronic circuits of the type specified. The present invention also relates to the use of capacitors according to the embodiments of the present invention in electronic circuits for generating, receiving and processing acoustic signals.

### BACKGROUND OF THE DISCLOSURE

Capacitors commonly used in electronics, are passive two-terminal components used to store electrostatic energy. There exists a wide variety of capacitors, each having at least two cladding elements (plates) separated by a non-conducting dielectric (i.e., electrical insulator). The cladding elements may be thin films, films or sintered metals, or conductive electrolyte spheres, etc. The non-conducting dielectric may be made of glass, ceramic, plastic, air, vacuum, paper, mica, and oxide layers, etc.

An ideal capacitor has no energy dissipation (as opposed to a resistor), and its capacity is characterized by a constant capacitance C, defined as the ratio of electric charge ±Q on each cladding element to the potential difference V between them. The capacitors have a larger capacitance when there is a smaller gap between the cladding elements and when the cladding elements have a larger surface area. In practice, the dielectric between the cladding elements passes a small amount of leakage current, and also there is an electric field strength limit, known as the breakdown voltage. Capacitors are widely used in electronic circuits and have many applications in common electrical devices. Examples of these applications may include blocking the direct current (DC) while allowing alternating current (AC) to pass, smoothing out the output of power supplies, tune radios to particular frequencies, or stabilize voltage or power flows.

Capacitors play an important role in the processing of acoustic signals, as they may be used, for example, in audio crossover system designs, i.e., circuitry that are used to split the incoming audio signal into separate frequency bands, allowing the audio signals to be processed separately before they are mixed again together. As an example, in loudspeakers, crossovers allow the audio signal to be split into low frequency and high frequency bands, covering the entire audio spectrum, that can be separately routed to loudspeakers optimized for those bands.

There are two types of crossover systems: passive crossovers and active crossovers. Passive crossovers are built entirely with passive components, such as for example, resistors, conductors, and capacitors that are connected in a suitable way to provide low-pass, high-pass, or bandpass filters. Passive crossovers may directly switch between outputs of the amplifier and the speaker, and thus consist of components which are capable of operating at high power, which are relatively expensive and may have large dimensions. In order to protect speakers (especially tweeters) in crossovers, resistors are placed in series with the speaker, limiting the power level supplied to the speaker. The advantage of passive crossovers is their relatively simple construction and no need to bring external power supply to them. The disadvantage includes the need for expensive elements, such as for example, copper inductors that are resistant to high capacities. These features are the reason why passive crossovers are used in most domestic and studio loudspeakers.

On the other hand, active crossovers are built with both passive components, i.e. resistors and capacitors, and active operational amplifiers. Active crossovers are switched between the sound source and amplifier, and therefore they work with low-voltage signals, which advantageously allows for use of inexpensive, smaller resistors and capacitors. Through the use of operational amplifiers, active crossovers enable the creation of low-pass filters without using large and expensive inductors. The advantage of active crossovers is their ability to easily and accurately reproduce the audio signal, using low-cost components, with a frequency response which is independent of dynamic changes. The disadvantage includes the need for supplying additional power to the operational amplifiers. Active crossovers are mainly used in professional kits, such as for example, studio monitor speakers as well as Hi-End.

Various solutions concerning the use of graphene in manufacturing of capacitors may be found in the existing prior arts. For example, U.S. Patent Application Publication No. 20140111906 discloses electrolytic capacitors with a graphene-based dielectric layer. On the other hand, the Chinese Patent No. CN 101894679 B discloses the structure and method of manufacturing flexible super-capacitors, in which graphene is used as one of the materials to produce flexible electrodes. Moreover, the U.S. Pat. No. 7,623,340 B1 discloses a method of manufacturing supercapacitor or ultracapacitor electrode materials based on nanocomposites, and more specifically, using graphene flakes and a bonding substance, enabling electrolyte fluid in-flow. However, all these solutions do not provide the required characteristics that enable their use in electronic acoustic signal processing circuits. This makes it desirable to create a capacitor of a small size and weight that could be used in, among others, audio systems without compromising the quality of the audio being processed.

### SUMMARY OF THE INVENTION

In order to minimize the possible opportunities for the operation of capacitors as propagation and receiving parts, i.e. resonant circuits receiving or generating sub- or super-acoustic, which can cause harmful oscillations of the power amplifier, it is necessary to keep a greater distance between the speaker and power cables (low-current). The problem often occurring with power amplifiers are the low-frequency acoustic currents, which occur most often when connected to a load of an inductive character, for example, speaker transformers in tube amplifiers SE, as well as in poorly designed transformers tube in push-pull amplifiers. Not only expensive audio amplifiers are equipped with active protection circuit speakers, as well as systems analyzing interdependencies between inputs and outputs, in order to quickly correcting performance characteristics of the amplifier, de facto, in such a situation degradation of the audio signal information occurs.

By using the graphene capacitor, in accordance with the embodiments of the present invention, we avoid these undesirable physical and electroacoustic phenomena inducing of various types of interference in nets of vacuum tubes, transistors gates databases and audio, as well as input circuits operational amplifiers. The use of capacitors constructed on the basis of graphene has a positive effect on the operation of individual degrees LF and significantly affects the quality and fidelity of sound reproduction by the system or audio device.

According to the embodiments of the present invention, the capacitor includes two electric cladding separated by a layer of electrically insulating polymer in the form of wound tapes arranged in a housing. Each of said electric claddings is electrically connected to an electrical connector which is led outside the housing, wherein the electrical cladding includes a layer of graphene. Preferably, the graphene layer is a layer made with one of the following structures:
idiopathic graphene layer, in particular, a two-dimensional layer or in the form of nanotubes,
graphene layer, in particular, a two-dimensional layer or in the form of nanotubes embedded on the surface of a single polymer layer,
idiopathic doped graphene layer, in particular, a two-dimensional layer or in the form of nanotubes, and
doped graphene layer, in particular, a two-dimensional layer or in the form of nanotubes embedded on the surface of a single polymer layer.

In a preferred embodiment, the polymer layer is a polymer selected from the group consisting of polyethylene terephthalate (PET), polyethylene naphthalate (TEN), polyethersulfone (PES), and polycarbonate (PC), polypropylene (PP), poly(ethylene oxide) (PEO), poly(vinyl chloride) (PVC), synthetic rubber, polyethersulfone (PES), polycarbonate (PC).

Preferably, the capacitor according to the embodiments of the present invention is contained in a protective layer of electrical insulation with a very high resistance, particularly made of Teflon, alumina (Al₂O₃) or tantalum oxide (Ta₂O₅).

In preferred embodiments, the housing of the capacitor is made of aluminium, poly (vinyl chloride) (PVC) or polypropylene (PP). Preferably, the housing of the capacitor may be also covered on its outside with plastic materials, selected from the group consisting of poly (vinyl chloride) (PVC), high density polyethylene (HDPE), low density polyethylene (LDPE), polypropylene (PP) or poly (ethylene terephthalate) (PET).

Embodiments of the present invention also encompasses the use of such a capacitor as an element of electronic circuitry of the audio system. Thus, the present invention relates, in particular, to capacitors made of graphene with the following characteristics:
a vast electron flow velocity, about 1/300 the speed of light for the flow of electrons in the medium of graphene,
substantial indifference to ubiquitous electromagnetic energy interference with low and high field intensity at high frequencies,
no formation of oscillations of a hum under the influence of electromagnetic energy at a frequency of 50 Hz and harmonics of high electromagnetic field intensity in an environment where they are located, such as for example, in long power cables, transformers, and power supply circuits, etc.,
very low inductance and low resistance, such that these parameters minimally affect the sonic qualities of the audio systems working on graphene-based capacitor,
relatively low weight compared to other capacitors currently on the market, which are constructed based on conventional technologies.
lack of parasitic excitation in audio systems, and more of sub- than super-acoustic occurring compared to generally used capacitors built based upon materials other than graphene,
lack of additional electromagnetic screens, which often in addition to improving these properties and performance degrade them and generate unnecessary costs,
ability to work as a key element of an active filter system powering the analog audio system,
ability to work as a key element of the electrical isolation of the supply voltage of the analog audio parts,
may be used as coupling active degrees of LF,
may be used as speaker crossover filters, and
may be used as DC component blocking capacitors occurring between degrees of audio reinforcement and load, while simultaneously transmitting variable components.

Due to the above-mentioned features, graphene capacitors may be implemented, for example, in laboratory measuring devices and be used in speaker systems, providing clean detail, neutral, and fully controlled sound, reaching our consciousness, subconscious and superconscious.

According to the embodiments of the present invention, the passive audio track component, as described above, may be used in professional and commercial audio and video equipment systems. Accordingly, the capacitors may be used by acoustic devices or acoustic track designers, active and passive speaker crossover designers, and electro-acousticians, sound engineers and producers, musicians, music lovers, audiophiles, and the like. More specifically, the capacitor according to the embodiments of the present invention may be used in microphone tracks, mixer elements, consoles, digital signal processors used in systems, such as for example, noise gates, filters, dynamics compressors, parametric equalizers (EQ), limiters and other types of equipment used in audio technology.

Moreover, these capacitors may be used, whenever coupling elements for separating amplifying stages and filters for separating the audio signal frequency bands are needed. In addition, they may also be used as a major element of analog audio signals in active supply filter systems or in voltage electrical isolation systems, or as a connector. Furthermore, the capacitors according to the embodiments of the present invention may also be used as mono or stereo connectors in analog audio signal systems.

### BRIEF DESCRIPTION OF THE DRAWINGS

The present disclosure is described in conjunction with the appended figures:

FIG. 1 depicts a schematic diagram of a capacitor with graphene cladding.

FIG. 2 is a cross-sectional view of an embodiment of a capacitor with graphene cladding structure.

FIG. 3 illustrates a physical view of different types of graphene capacitors.

In the appended figures, the following reference label are used to distinguish various components: 1—a layer of electrically insulating polymer; 2—electrical insulation; 3—capacitor cladding including graphene (its particular forms were designated by 3a, 3b, 3c, 3d); 4—housing; 5—plastic; 6 & 7—electrical connectors.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment(s) of the disclosure. It should be understood that various changes may be made in the function and arrangement of elements without departing from the spirit and scope of the invention as set forth in the appended claims.

This disclosure relates in general to audio signal-processing systems. More specifically, it relates to a new graphene capacitor which is used for coupling, isolating and/or separating an acoustic signal. Capacitors for audio applications are extremely important elements, as they perform several important functions in passive acoustic track systems. In electro-acoustic circuits and systems, often undesirable changes may happen to sounds of music programmes, music, which unfortunately may have a very significant impact on the clarity of the sound of musical instruments and speeches. The use of poor quality capacitors clearly breaks or degrades readability, colour, understanding and sound quality. Acoustic track capacitors, together with a number of elements of the acoustic track systems, undoubtedly form the type of transmission medium for acoustic waves to cover the whole sound spectrum, connecting the sound source, preamplifiers, and amplifiers. They are even present in passive and active speakers. Audio capacitors are designed for example to allow the passage of small amplitude signals and large amplitude signals to and from the audio amplifier while blocking the DC component in the various levels of circuit design of small and large capacities. Therefore, their quality is extremely important if we want fidelity and quality of sound reproduction, fed from the source to the amplifier, or for understanding and correct reading of information contained in an audio signal.

At the same time the quality of the capacitors within the eclectic parameters influences the static operating conditions, that is, the operating point of the active elements. Capacitors are mainly characterized by their capacity and their breakdown voltage insulation. The size of a capacitor and its weight is closely related to the above-mentioned parameters, such that the higher the capacitance and the breakdown voltage the lager is its overall dimensions. It is usually not allowed that breakdown voltage of the capacitor be equal to the voltage we want to block. If the capacitor works only in alternating current (AC) and voltage system, the limit for alternating voltage can be approx. 40% higher than a constant limit voltage. It is well known that passive components of an acoustic track system are unwanted elements. Thus, in the preferred embodiments, it is best if there are no capacitors in the audio track system. Accordingly, the high-end audio equipment structures of a sound track system are designed to have almost no capacitors. However, it is very difficult to achieve 100% elimination of capacitors in the audio track systems.

Another important parameter of capacitors is their resistivity, which is related to the surface of their claddings. The greater the surface of the claddings, the lower the resistance, which is favourable for direct impact on the power fed back into the speakers. Such a capacitor also shows a lower leakage current; the larger it is the more influence it has on the deterioration of the separation of the permanent component between these levels. In addition, the lower the resistivity of a capacitor claddings, the lower is the energy dissipation in the capacitor, therefore a smaller amount of heat is released during element operation—this is important in the operation of capacitors for the varying component of large amplitude. Thus, using a capacitor with a larger cross-section is more favourable, making more energy sources reach the speaker unit—it is important information directly relating to users of audiophile tube power amplifiers in configuration SE/Single End/whose output is approximately 8W, for amplifiers built on tubes, for example 300B, 2A3 and similar or transistor amplifiers working in the class A. with an output power not usually exceeding approximately 15W.

Similar expectations may apply to the capacitors connecting a turntable and a preamplifier, but in this case we do not use and do not have high power of the transmitted signal more resistant to external interference. On the contrary, in this scenario, we are dealing with small signals, where very high resistance is important and their susceptibility to interference reaching and besieging the capacitors from the outside negligible. When strengthening this type of signals minimal own medium noise and temperature stability (drift) are necessary and indeed indispensable. Unwanted own characteristics, though characteristic of each medium, will always be present, i.e. parasite capacitance, inductance, resistivity, which have a direct impact on the spectrum and audio quality, or the quality of information, which is reinforced in subsequent stages audio system can affect the information. As previously mentioned—low quality capacitors could mislead.

Embodiments of the present invention provide a solution, in that there is no need for using relatively large and heavy capacitors, which leads to the use of better, thinner, lighter, and faster capacitors without any loss of sonic values. The usage of the graphene capacitor eliminates other problems with audio devices in the case of employing a capacitor built based on the graphene technology in comparison with technology based, for example, on copper hardly occur, i.e. oscillation of parasitic super-acoustic capacity, observable on the oscilloscope—the sign of which is usually unjustified heating of the amplifier heat sink, even with minimal input signal, and even in its absence due to the nature of the medium (inductance, parasitic capacitance, internal resistance, resonance of high frequency voltages).

In addition, any possible oscillations of a hum impact of SEM (strength of electromagnetic energy at a frequency of 50 Hz harmonics and sub harmonics) high-field inducing the poor quality capacitors can also be prevented. Oscillations can cause hyperactivity of the protection circuitry, resulting in malfunctioning of the amplifier. In the case of the use of the presented graphene capacitor active audio tracks can be minimized, so low pass filters in the amplifier degrading sound, bindings (twisting) of the conventional speaker cables brought out of the power amplifier or can be dispensed with. This can affect the appearance of parasitic capacitance and lowering the frequency response of audio bandwidth thereby worsening the quality of sound reproduction and the capacitor speed.

It is well known that every element of the acoustic and design of the preamplifiers, amplifiers, transmission lines has an effect on the nature of sound quality produced by the power amplifier, and consequently speaker units with the turnouts. The type and quality of the components used to build audio transmission paths connecting the particular microphone preamplifiers, CD and DVD drives with power amplifiers and speaker systems have significant and not contestable influence on the character and quality of sound creation. In a situation the capacitor according to the embodiment of the present invention are used one has the impression that the character of the sound is created only by active elements. The transmission line—the presence of media on the basis of graphene capacitors in terms of acoustics is not felt. Transmission, reproduction and creation of sound occur by means of active audio track. We achieve the desired effect of “exclusion” of capacitors in the audio path that, in fact are, physically there.

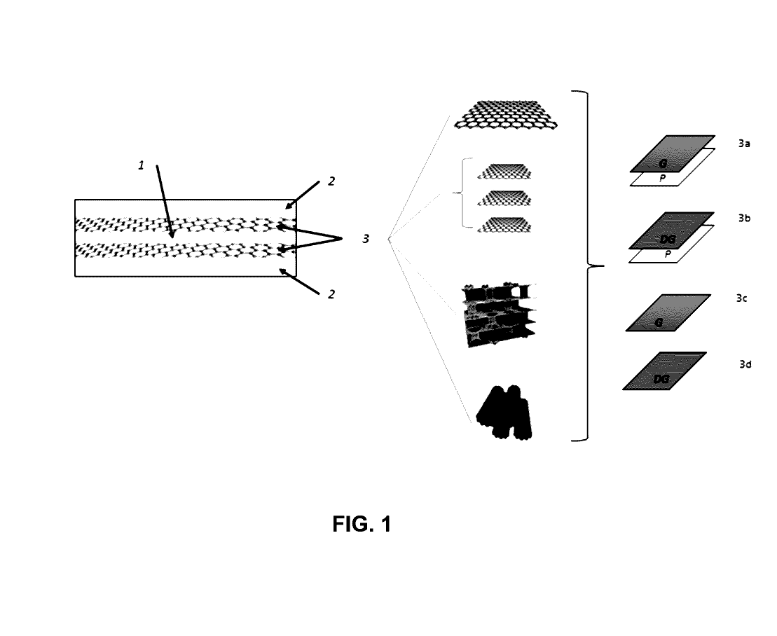

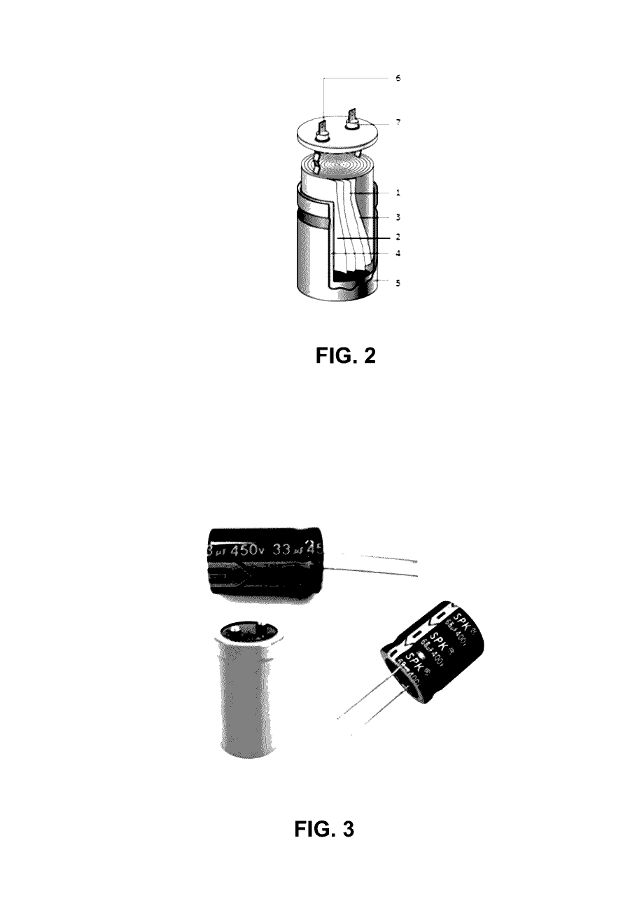

Referring first to FIG. 1, a schematic diagram of a capacitor with graphene cladding is shown. As shown in this figure, the graphene capacitor is preferably made of a layer of graphene (3a, 3b, 3c and/or 3d) arranged in a polymer layer 1, which acts as a high-quality insulator which is not a carrier of information. Transmission medium is graphene that acts as a capacitor cladding 3, where electrodes 6 & 7 are galvanically fixed to their outside surface (FIG. 2). The flexible material of the capacitor (FIG. 1)—is preferably a material having a structure composed of one, two or more components with different properties. It should be understood that the properties of the composites are not the sum or average of properties of its components, and the material used in its construction exhibits anisotropy of physical properties.

In the preferred embodiment, one important component is a binder, in this case, any polymer 1, which can further guarantee the consistency and elasticity of the membrane, and the other component is a layer of graphene (3a, 3b, 3c and/or 3d), which satisfies the basic properties of the capacitor cladding 3.

The components of capacitor cladding 3 are preferably made in one of the following ways:
intrinsic graphene layer 3c: two-dimensional or nanotubes structure,
a layer of graphene 3a: two-dimensional or nanotubes structure “embedded” on the surface of a single layer of polymer,
intrinsic graphene doped layer 3d: two-dimensional or nanotubes structure, and
a doped layer of graphene 3b: two-dimensional or nanotubes structure “embedded” on the surface of a single layer of polymer.

In the preferred embodiment, the polymer layer 1 is a polymer selected from the group consisting of polyethylene terephthalate (PET), polyethylene naphthalate (TEN), polyethersulfone (PES), and polycarbonate (PC), polypropylene (PP), poly(ethylene oxide) (PEO), poly(vinyl chloride) (PVC), synthetic rubber, most preferably: polyethersulfone (PES), polycarbonate (PC), which ensure its integrity, hardness, flexibility, resistance to compression. It should be noted that graphene layers provide a very good conductive properties while maintaining the transparency of the material. As shown in FIG. 1, the graphene capacitors are preferably sealed in a protective layer of Teflon insulation 2 with a very high resistance. The protection layer 2 is electrically neutral, so that it does not affect the nature of information transmitted by the capacitor.

The graphene layer (3a, 3b, 3c and/or 3d) is preferably uniform and forms a surface characterized by a uniform level of electro-acoustic-wave propagation, which is audio signal composed in many ways. Since graphene has a one-dimensional (homogeneous) structure, electrons move in one plane in a controlled manner (as free electrons) either forward or backward (while e.g. in copper-free electrons move chaotically and in a disordered way in a multidimensional structure). Capacitors built with graphene provide high level of electroacoustic properties, which is a transmission material of almost perfect characteristics. In this embodiment, a reference signal from the source, which is a turntable, a preamplifier, a power amplifier, and the like, is regarded as the input signal having minimum loss and short propagation time, transferring in a short period of time electric power between the stages of low-frequency to a load that other amplification stages or speaker crossovers, passive filters loaded with little resistance with low noise of their own. The input signal is almost identical to the reference signal source.

The above-mentioned element is characterized by significant indifference to the induction of a spurious HF (high frequency energy) electromagnetic energy that passes through the graphene capacitor in different areas. It shows also excellent resistance to RFI (Radio Frequency Interference) and EMI (Electro Magnetic Interference), which results in minimum parasitic inductance of the electrical structure of graphene. Moreover, the present passive audio track component meets the requirements of electro-mechanical strength, such as for example, mechanical resonance, thermal stability, high accuracy and stability of represented capacity. FIG. 2 illustrates a cross-sectional view of an embodiment of a capacitor with graphene cladding structure. Referring next to FIG. 3, a physical view of different types of graphene capacitors is shown.

While the principles of the disclosure have been described above in connection with specific apparatuses, it is to be clearly understood that this description is made only by way of example and not as limitation on the scope of the invention.

What is claimed is:

1. A capacitor comprising two electric cladding elements separated by a layer of electrically insulating polymer in a form of a wound tape arranged in a housing, said electric cladding elements comprises at least one graphene layer, wherein each of the electric cladding elements is electrically connected to electrical connectors led through an external casing.

2. The capacitor as recited in claim 1, wherein the at least one graphene layer comprises an idiopathic graphene layer, in a two-dimensional layer structure or is in a form of nanotubes.

3. The capacitor as recited in claim 1, wherein the at least one graphene layer comprises a graphene layer in a two-dimensional layer structure or is in a form of nanotubes embedded on a surface of said polymer layer.

4. The capacitor as recited in claim 1, wherein the at least one graphene layer comprises an idiopathic doped graphene layer, in a two-dimensional layer structure or in a form of nanotubes.

5. The capacitor as recited in claim 1, wherein the at least one graphene layer comprises a doped graphene layer, in a two-dimensional layer structure or in a form of nanotubes embedded on a surface of said polymer layer.

6. The capacitor as recited in claim 1, wherein the layer of electrically insulating polymer is a polymer selected from the group consisting of polyethylene terephthalate (PET), polyethylene naphthalate (TEN), polyethersulfone (PES), and polycarbonate (PC), polypropylene (PP), poly(ethylene oxide) (PEO), poly(vinyl chloride) (PVC), synthetic rubber, polyethersulfone (PES), and polycarbonate (PC).

7. The capacitor as recited in claim 1 further comprising a protective layer of electrical insulation having a high resistance, wherein the protective layer is made of Teflon, alumina (Al₂O₃), or tantalum oxide (Ta₂O₅).

8. The capacitor as recited in claim 1, wherein the housing is made of aluminium, poly vinyl chloride (PVC), or polypropylene (PP).

9. The capacitor as recited in claim 1, wherein an outside surface of the housing is covered with a plastic material.

10. The capacitor as recited in claim 9, wherein in the plastic material is selected from the group consisting of poly vinyl chloride (PVC), high density polyethylene (HDPE), low density polyethylene (LDPE), polypropylene (PP), or poly(ethylene terephthalate) (PET).

11. An audio system having an electronic circuitry comprising the capacitor of claim 1.
